(19) United States
(12) Patent Application Publication
(10) Pub. No.: US 2020/0249856 A1
(43) Pub. Date: Aug. 6, 2020

(54) MEMORY MODULE FOR AUTHENTICATION INSTALLED ON RECYCLE CARTRIDGE CAPABLE OF INITIALIZING

(71) Applicants: Dong Hyun KIM, Seongnam-si (KR); Young Wook CHEON, Seoul (KR); Chang Ho YOU, Seoul (KR)

(72) Inventors: Dong Hyun KIM, Seongnam-si (KR); Young Wook CHEON, Seoul (KR); Chang Ho YOU, Seoul (KR)

(21) Appl. No.: 16/751,173

(22) Filed: Jan. 23, 2020

(30) Foreign Application Priority Data
Jan. 31, 2019 (KR) 10-2019-0012471

(51) Int. Cl. G06F 3/06; G06F 21/34; G06K 15/00

(52) U.S. Cl. CPC G06F 3/0632; G06F 21/34; G06F 3/0607; G06F 3/0673; G06K 15/407

(57) ABSTRACT

The present disclosure relates to a memory module for authentication to be installed on a recycle cartridge capable of initializing, the memory module comprising: a Ferroelectrics Random Access Memory (FRAM); and a controller electrically connected to the FRAM and configured to communicate with an initialization module to perform an initialization authentication algorithm together with the initialization module, thereby initializing the FRAM when the initialization authentication is completed.

According to the present disclosure, the memory module for authentication to be installed on an recycle cartridge where a single unit FRAM is mounted has an effect of the capability of initializing the FRAM and thus reusing the FRAM.

### 1. FIELD

The present invention relates to a memory module for authentication to be installed on a recycle cartridge capable of initializing, and more particularly, to a memory module for authentication to be installed on a recycle cartridge capable of initializing, wherein a single unit FRAM is mounted, and the FRAM may be initialized and reused.

### 2. BACKGROUND

A cartridge being installed on an imaging device such as a printer and copy machine is equipped with a module for authentication installed to authenticate the cartridge and to transceive data with the imaging device. Such a module for authentication is composed of a nonvolatile memory such as Electrically Erasable Programmable Read-Only Memory (EEPROM) and Flash memory, and other components. The reason for using the nonvolatile memory in the module for authentication is to maintain the information stored in the memory even when power is not applied to the module.

In recent days, modules for authentication that apply Ferroelectrics Random Access Memory (FRAM) instead of EEPROM or Flash memory, are being developed. Compared to EEPROM or Flash memory, FRAM requires shorter time for data reading, data writing and so forth. Moreover, while with EEPROM or Flash memory, data must be erased first before writing, FRAM has an advantage that data may be written right away without having to erase data. FRAM also has an advantage of significantly higher Endurance than Flash memory or EEPROM. Due to the aforementioned advantages, recently, FRAM is being increasing applied to authentication modules, which is expected to continue for the time being.

Meanwhile, in the case of a cartridge installed on an imaging device, when the cartridge is finished being used, the cartridge must be replaced, which causes economic burden and environmental problems.

Due to these problems, recycle cartridges are widely being used, and a module for authentication to be installed on a recycle cartridge enables repeated reuse of recycle cartridge cases, and thus there are various advantages in economical and environmental aspects. However, once a cartridge is finished being used, a module for authentication to be installed on a recycle cartridge cannot be initialized just as the aforementioned genuine products, and thus cannot be reused either. Therefore, due to this reason, there occurs a problem that in the case of recycling a recycle cartridge case to reproduce a recycle cartridge, a new recycle module for authentication has to be prepared and installed.

### SUMMARY

Therefore, a purpose of the present disclosure is to resolve the aforementioned problems of prior art, that is, to provide a memory module for authentication to be installed on a recycle cartridge capable of initializing, and more particularly, to a memory module for authentication to be installed on a recycle cartridge capable of initializing, wherein a single unit FRAM is mounted, and the FRAM may be initialized and reused.

The aforementioned purpose according to the present disclosure may be achieved by a memory module for authentication to be installed on a recycle cartridge capable of initializing, the memory module including a Ferroelectrics Random Access Memory (FRAM); and a controller electrically connected to the FRAM and configured to communicate with an initialization module to perform an initialization authentication algorithm together with the initialization module, thereby initializing the FRAM when the initialization authentication is completed.

Further, the controller may include a first communicator configured to exchange information with the initialization module; a second communicator configured to exchange information with the FRAM; a pseudo random unit configured to generate pseudo random information based on information transmitted from the FRAM; an authenticator configured to perform an initialization authentication algorithm based on the pseudo random information; and a main controller configured to control the first communicator, the second communicator, the pseudo random unit and the authenticator, and when the initialization module performs the initialization authentication algorithm based on the pseudo random information and the authenticator performs the initialization authentication algorithm based on the pseudo random information, to initialize the FRAM in response to a command from the initialization module.

Further, the FRAM may store a plurality of initial data corresponding to a plurality of types of the recycle cartridges, respectively, and the pseudo random unit may have a plurality of methods for generating a plurality of pseudo random information corresponding to the plurality of initial data based on the plurality of initial data, respectively.

Further, the pseudo random unit may be provided by a Linear Feedback Shift Register (LFSR).

Further, the FRAM and the controller may communicate in a Serial method.

According to the present disclosure, the memory module for authentication to be installed on a recycle cartridge, where a single unit FRAM is mounted, has an effect of being capable of initializing the FRAM and thus reusing the FRAM.

### BRIEF DESCRIPTION OF THE DRAWINGS

FIG. 1 is a block diagram of an entirety of a memory module for authentication to be installed on a recycle cartridge capable of initializing according to an embodiment of the present disclosure;

FIG. 2 illustrates the flow of operations where the information is being stored in the mirror memory when power is applied to the memory module for authentication to be installed on a recycle cartridge capable of initializing according to an embodiment of the present disclosure;

FIG. 3 illustrates the flow of operations of reading the information from the mirror memory of the memory module for authentication to be installed on a recycle cartridge capable of initializing according to an embodiment of the present disclosure;

FIG. 4 illustrates the flow of operations where the information of the FRAM is being written in the mirror memory of the memory module for authentication to be installed on a recycle cartridge capable of initializing according to an embodiment of the present disclosure;

FIG. 5 illustrates the flow of authentication operations of the memory module for authentication to be installed on a recycle cartridge capable of initializing according to an embodiment of the present disclosure;

FIG. 6 illustrates a first flow of initializing operations of the memory module for authentication to be installed on a recycle cartridge capable of initializing according to an embodiment of the present disclosure;

FIG. 7 illustrates a second flow of initializing operations of the memory module for authentication to be installed on a recycle cartridge capable of initializing according to an embodiment of the present disclosure; and

FIG. 8 illustrates a third flow of initializing operations of the memory module for authentication to be installed on a recycle cartridge capable of initializing according to an embodiment of the present disclosure.

### DETAILED DESCRIPTION

Hereinbelow, some embodiments of the present disclosure will be described in detail with reference to exemplary drawings. It should be noted that when adding reference numerals to the components in each drawing, the present specification used like reference numerals for like components as much as possible, even if they were indicated in other drawings.

Further, in describing the embodiments of the present disclosure, if it is determined that a related well-known configuration or function interrupts understanding the embodiments of the present disclosure, detailed explanation of the well-known configuration or function shall be omitted.

Further, in describing the components of the embodiments of the present disclosure, terms such as first, second, A, B, (a), (b) and the like may be used. These terms are used only to distinguish components from other components, and thus they do not limit the nature, sequence or order and so forth of the corresponding component.

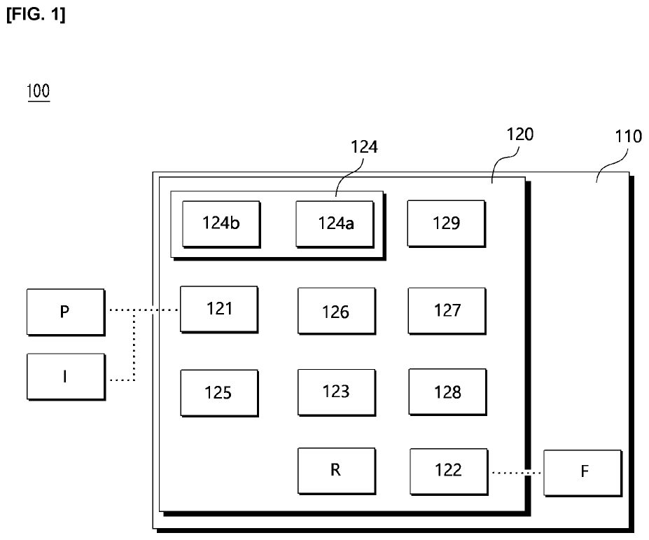

FIG. 1 is a diagram illustrating an entirety of a memory module for authentication to be installed on a recycle cartridge capable of initializing according to an embodiment of the present disclosure.

Hereinafter, a memory module for authentication to be installed on a recycle cartridge capable of initializing according to an embodiment of the present disclosure will be described in detail with reference to the drawings attached.

First of all, here, the initialization module I is configured to initialize the memory module for authentication to be installed on a recycle cartridge capable of initializing 100 according to an embodiment of the present disclosure, to be installed on a recycle cartridge, and is electrically connected to the memory module for authentication to be installed on a recycle cartridge capable of initializing 100 according to an embodiment of the present disclosure.

As illustrated in FIG. 1, the memory module for authentication to be installed on a recycle cartridge capable of initializing 100 according to an embodiment of the present disclosure includes a FRAM F, substrate 110 and controller 120.

The FRAM F refers to Ferroelectrics Random Access Memory, that may be installed on the aforementioned substrate 110.

It takes a very short time for the FRAM F to conduct data reading, writing and the like compared to EEPROM or Flash memory, and while with EEPROM and Flash memory, data must be erased first before being rewritten, the FRAM F has an advantage that it enables writing data without the process of erasing data, and further, it also has an advantage of much higher Endurance than the EEPROM or Flash memory.

In this FRAM F, various program information related to the authentication, operations and the like of the recycle cartridge are stored. Therefore, initializing the memory module for authentication means initializing the FRAM F.

Meanwhile, in the FRAM F, data for initializing the FRAM F, that is, initial data, is stored, wherein the initial data being stored in the FRAM F may be provided in plurality so as to correspond to a plurality of types of recycle cartridges, respectively. The reason for the plurality of initial data is to diversify the operation methods for generating the pseudo random information by recycle cartridge type, that is, by memory module for authentication to be installed on a recycle cartridge, when generating the pseudo random information in the pseudo random unit R that will be described hereinafter.

The substrate 110 is where the controller 120 that will be described hereinafter and the FRAM F are installed. A printed circuit board (PCB) may be provided as the substrate 110. Such a substrate 110 is installed on the recycle cartridge and communicates with the imaging device P.

Meanwhile, instead of having a separate substrate 110, the aforementioned FRAM F and the controller 120 that will be described hereinafter, may be configured in one package form as a multi-chip package (MCP).

The controller 120 is configured to communicate with the initialization module I to perform an initialization authentication algorithm together with the initialization module I, thereby initializing the FRAM F when the initialization authentication is completed, and to communicate with the imaging device P so that the authentication of the recycle cartridge is conducted in the imaging device P, and to perform operations for information reading/writing. The controller 120 is also electrically connected to the FRAM F, and is provided to be able to communicate with the initialization module I.

More specifically, such a controller 120 includes a first communicator 121, second communicator 122, mirror memory 123, buffer 124, authenticator 125, main controller 126, encoder 127, decoder 128, resetter 129 and pseudo random unit R.

The first communicator 121 is configured to exchange information with the imaging device P or initialization module I. The first communicator 121 is installed on the aforementioned substrate 110 and communicates with the imaging device P or the initialization module I to exchange information. The first communicator 121 is also electrically connected to the main controller 126 that will be described hereinafter, to exchange information.

The second communicator 122 is configured to exchange information with the mirror memory 123. The second communicator 122 is installed on the aforementioned substrate 110 to communicate with the FRAM F to exchange information. The second communicator 122 is also electrically connected to the encoder 127, that will be described hereinafter, to exchange information.

The mirror memory 123 is configured, when receiving a writing command from the imaging device P, to store the information being transmitted from the FRAM F, and when receiving a reading command from the imaging device P, to transmit the stored information to the imaging device P. A volatile memory, such as Random Access Memory (RAM), Register and the like, is provided as the mirror memory 123, and the mirror memory 123 is electrically connected to the main controller 126 and the authenticator 125 that will be described hereinafter.

A genuine product authentication module, that is, a chip module with an embedded FRAM, has the FRAM integrated inside the chip module, and thus without limitation of the number of pins, Parallel communication may be performed in connection with an address, data and control signal. There are single unit FRAMs that support Parallel communication, being sold on the market, but unlike the embedded type FRAM, such a single unit FRAM has a large number of pins, which increases the size of the package. Therefore, such a single unit FRAM is not appropriate to be applied to modules for cartridge authentication, that have limitation in module sizes. Thus, when using the single unit FRAM, a Serial communication type FRAM needs to be used.

Serial communication is conducted in the form of address, data and control command being transmitted in a sequential order, and thus, compared to Parallel communication, there occurs a problem of inevitable time delay during communication, and during repetitive writing or reading operations. Therefore, in the case where the aforementioned Serial communication type FRAM F is being used, RAM, Register and the like must be used as the high-speed mirror memory 123 as aforementioned, and it must be configured such that, when power is applied, in a reset section, the main controller 126 transmits the information of the FRAM F to the main mirror 123 of the authentication cartridge control device, to synchronize the reading/writing timing of the mirror memory 123 to the same timing as the embedded FRAM.

Due to the aforementioned reason, with this mirror memory 123, the Serial type FRAM F may be utilized to configure the module, and accordingly, advantages such as improvement of information processing speed and the like between the imaging device P and the recycle cartridge may be realized effectively.

The buffer 124 is configured, when the information being transmitted from the imaging device P is stored in the aforementioned mirror memory, to store information identical to the information stored in the mirror memory 123, and to transmit the stored information to the FRAM F, and thus according to such a buffer 124, it is possible to prevent information loss error of the FRAM F due to power off.

The information being stored in the mirror memory 123 must be stored in the FRAM F as well, and if power of the imaging device P is turned off at a time point where the information stored in the mirror memory 123 is not stored in the FRAM F, loss of information occurs in the volatile memory provided as the mirror memory 123, and the information is not recorded in the FRAM F. In this case, an error occurs where the information in response to a writing command conducted in the imaging device P is not recorded in the FRAM F again even if power is turned back on in the imaging device P.

According to the aforementioned buffer 124, the aforementioned error may be prevented. The operations and processes of the aforementioned configuration will be described in detail hereinafter.

The buffer 124, more particularly, includes a writing buffer 124a and a writing buffer controller 124b.

In the case where a writing command is transmitted from the imaging device P to the main controller 126 and thus information is to be stored in the mirror memory 123 in response to the writing command, the writing buffer 124a performs the function of storing the same information as the information stored in the mirror memory 123. Here, the information being stored includes information of data and the address in which the data is to be written.

The writing buffer controller 124b is configured to control the aforementioned operations of the writing buffer 124a. The writing buffer controller 124b performs the function of transmitting the information stored in the writing buffer 124a to the FRAM F using a reading address pointer and a writing address pointer.

When the writing command and information are transmitted from the imaging device P to the main controller 126, the main controller 126 transmits the data to the corresponding address of the mirror memory 123 so that the data is stored in the mirror memory 123, and at the same time, stores the same information in the writing buffer 124a. Thereafter, the main controller 126 sequentially records the information of the corresponding address of the mirror memory 123 and the data being stored in the mirror memory 123, in the writing address pointer, wherein the writing address pointer becomes larger than the reading address pointer. Here, the writing buffer controller 124b monitors the state of the writing address pointer and the reading address pointer, and compares the size of the writing address pointer and the reading address pointer, and if the writing address pointer is larger than the reading address pointer, the writing buffer controller 124b reads the information stored in the writing buffer 124a, that is, the address and the data, and transmits the address and the data to the second communicator 122. The writing buffer controller 124b repeats the above process while increasing the reading address pointer by the size read until the size of the writing address pointer and the size of the reading address pointer become identical to each other. Through the aforementioned process, information identical to the information stored in the mirror memory 123 is transmitted to the FRAM F.

Therefore, even if power in the imaging device P is turned off at a time point where information is stored in the mirror memory 123 but the same information is not stored in the FRAM F, since the information that should have been stored in the FRAM F is stored in the buffer 124, after the power is applied, when the information stored in the buffer 124 is transmitted to the FRAM F again, the information that should have been stored in the FRAM F may be stored without loss.

The authenticator 125 is configured to generate an authentication result signal based on the information being transmitted from the imaging device P, and to transmit the generated authentication result signal to the imaging device P, and thus, by the authenticator 125, authentication of the recycle cartridge is performed.

An authentication command and a first authentication information generated from the imaging device P are transmitted to the authenticator 125 via the first communicator 121 and the main controller 126. Thereafter, the authenticator 125 reads a second authentication information from the mirror memory 123, performs an authentication algorithm based on the read second authentication information, and then generates the authentication result signal as a result. Here, SHA, DES, AES, HASH and the like may be used as an encoding algorithm for the authentication.

The authentication result signal consists of a first authentication result information for authentication between the imaging device P and the recycle cartridge, and a second authentication result information which is information that may be substituted for the first authentication information when authentication is repeated. Here, the first authentication result information is transmitted to the imaging device P again via the first communicator 121, to be used in the authentication, which means allowing the use of the recycle cartridge in the imaging device P.

Meanwhile, to initialize the FRAM F, the authenticator 125 performs the initialization authentication algorithm based on a fixed pseudo random information generated in the pseudo random unit R that will be described hereinafter.

When the pseudo random information that used to be sequentially generated by the pseudo random unit R, that will be described hereinafter, is fixed upon receiving the initialization authentication command from the initialization module I, the fixed pseudo random information is transmitted to the initialization module I and the authenticator 125, respectively, and the initialization module I and the authenticator 125 perform the initialization authentication algorithm, respectively, based on the transmitted pseudo random information. When the initialization authentication algorithm is conducted normally in the initialization module I, the first initialization authentication result information is generated, and when the initialization authentication algorithm is conducted normally in the authenticator 125, the second initialization authentication result information is generated.

Thereafter, the initialization module I transmits the first initialization authentication result information to the first communicator 121 so that the first initialization authentication result information is transmitted to the authenticator 125, and the initialization module I also receives the second initialization authentication result information generated from the authenticator 125 and conducts the initialization authentication based on the first initialization authentication result information generated by the initialization module I. That is, when the first initialization authentication result information and the second initialization authentication result information are identical to each other, the authentication is completed.

Meanwhile, at the same time, based on the first initialization authentication result information transmitted after the initialization authentication algorithm is performed in the initialization module I and the second initialization authentication result information generated by the authenticator 125, the authenticator 125 conducts the initialization authentication. That is, when the first initialization authentication result information and the second initialization authentication result information are identical to each other, the authentication is completed.

When the authentication is completed in the initialization module I and the authenticator 125, respectively, the initialization module I transmits the initialization command to the main controller 126 so that the main controller 126 initializes the FRAM F.

The main controller 126 is configured to control the first communicator 121, second communicator 122, mirror memory 123, buffer 124, authenticator 125, encoder 127, decoder 128, resetter 129 and pseudo random unit R, and to conduct various operations. The main controller 126 is also electrically connected to the first communicator 121, second communicator 122, mirror memory 123, buffer 124, authenticator 125, encoder 127, decoder 128, resetter 129 and pseudo random unit R.

When power is applied, the main controller 126 controls the mirror memory 123, encoder 127, second communicator 122 and resetter 129 to store the information of the FRAM F in the mirror memory 123; controls the first communicator 121, second communicator 122, mirror memory 123, buffer 124, encoder 127 and decoder 128 for the writing and reading in the FRAM F; and controls the first communicator 121, second communicator 122, mirror memory 123, buffer 124, encoder 127 and authenticator 125 for the recycle cartridge authentication.

Further, the main controller 126 controls the first communicator 121, second communicator 122, authenticator 125, encoder, decoder, resetter 129 and pseudo random unit R, for the initialization of the FRAM F.

The encoder 127 is configured to encode the information being stored in the FRAM F, and is electrically connected to main controller 126, the buffer 124 and the second communicator 122.

The decoder 128 is configured to decode the information encoded by the encoder 127 and is electrically connected to the second communicator 122 and the mirror memory 123.

Generally, a single unit FRAM does not have a separate encoding device, and thus in the case of using the single unit FRAM, the data being stored is exposed to the outside defenselessly. Therefore, in the mirror memory 123, the information to be stored in the FRAM F must be encoded by the aforementioned encoder 127, and must then be stored in the FRAM F.

In the case of 8 bit data being stored in address 0, for example, the encoding may be conducted using exclusive OR and bit negation of the address and data.

The resetter 129 is configured, when power is applied, to operate first and foremost to generate a reset section signal, and to transmit the generated reset section signal to the main controller 126. The resetter 129 is electrically connected to the main controller 126 so that it may perform the function of reading the FRAM F and storing the read FRAM F in the mirror memory 123.

Meanwhile, the resetter 129 is configured to operate first and foremost to generate a reset section signal, and to transmit the generated reset section signal to the main controller 126, when initializing the FRAM F. The resetter 129 is electrically connected to the main controller 126 so that the main controller 126 initializes the FRAM F.

The pseudo random unit R is configured to generate the pseudo random information based on the information being transmitted from the FRAM F to initialize the FRAM F, that is, the initial data. The pseudo random unit R is electrically connected to the first communicator 121, second communicator 122 and main controller 126.

When the reset section signal is generated in the aforementioned resetter 129, the main controller 126 transmits an initialization data reading command to the second communicator 122. Thereafter, when the initialization data of the FRAM F is transmitted to the second communicator 122, the pseudo random unit R sequentially generates the pseudo random information based on the initialization data being transmitted.

Thereafter, when the initialization authentication command generated in the initialization module I is transmitted to the pseudo random unit R, the pseudo random unit R stops the operation and fixes the pseudo random information. The fixed pseudo random information is transmitted to the aforementioned authenticator 125, and the authenticator 125 conducts the initialization authentication algorithm using the transmitted fixed pseudo random information.

Meanwhile, a Linear Feedback Shift Register (LFSR) may be provided as the pseudo random information unit R, wherein an initial value of the Register takes a fixed value, and the operation method is adjusted according to the initialization data value being transmitted from the FRAM F.

In the FRAM F, data is stored by recycle cartridge type such that the memory module for authentication may correspond to all various types of recycle cartridges. Here, the initial data for initializing the FRAM F is stored in the FRAM F in plurality according to the number of different types of the plurality of recycle cartridges.

That is, the pseudo random unit R must operate to correspond to such a structure of the FRAM F, and thus the pseudo random unit R diversifies the operation method by initial data type being stored in the FRAM F, when generating the pseudo random information.

According to the aforementioned structure of the pseudo random unit R, there is an advantage of the capability to conduct initialization on each of the plurality of memory modules for authentication used in such various types of recycle cartridges.

Meanwhile, the Linear Feedback Shift Register (LFSR) may be provided as the pseudo random unit R as aforementioned, singularly or plurally, but there is no limitation thereto. Thus, anything may be provided as the Linear Feedback Shift Register (LFSR) as long as it generates data in the pseudo random form.

Further, meanwhile, the reason why the pseudo random information is sequentially generated and then fixed in the pseudo random unit R is for the purpose to enable normal generation of the pseudo random information even in the case of repeatedly attempting initialization of the same memory module for authentication, having an operation error of other components of the memory module for authentication (that is, frequency generator, reset generator and the like) as a variable of the generation operation of the pseudo random information, or having a time error at an initial communication time point due to repetition of external communication signals through power ON/OFF as the variable of the generation operation of the pseudo random information.

Further, meanwhile, when the initialization of the FRAM F is terminated by exchanging information with the initialization module I, the pseudo random unit R conducts operations again. This is to change the value of the pseudo random information being generated when repeating the authentication command sequence.

According to the controller 120 that includes the first communicator 121, second communicator 122, mirror memory 123, buffer 124, authenticator 125, main controller 126, encoder 127, decoder 128, resetter 129 and pseudo random unit R as aforementioned, using the single unit FRAM, authentication of the recycle cartridge is conducted in the imaging device P in the same manner as the embedded FRAM chip module, and performing operations for information reading/writing may be easily realized.

As aforementioned, according to the memory module for authentication to be installed on a recycle cartridge capable of initializing 100 according to an embodiment of the present disclosure that includes the FRAM F, substrate 110 and controller 120, using the single unit FRAM, a FRAM type memory module for authentication may be prepared. Such a FRAM type memory module for authentication operates in the same manner as a genuine product module for authentication where a FRAM is embedded, and thus in the recycle cartridge, the authentication and data transmission speed between the recycle cartridge and the imaging device P may be significantly improved.

Further, according to the aforementioned memory module for authentication to be installed on a recycle cartridge capable of initializing 100 according to an embodiment of the present disclosure, in the recycle cartridge authentication memory module where a single unit FRAM F is mounted, there is an effect of initializing the FRAM F, and thus reusing the FRAM F.

Hereinafter, operations of the memory module for authentication to be installed on a recycle cartridge capable of initializing according to an embodiment of the present disclosure will be described in detail with reference to the drawings attached.

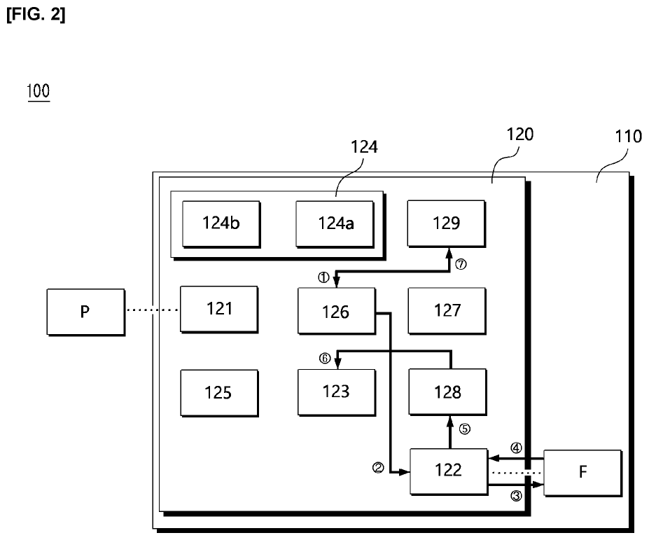

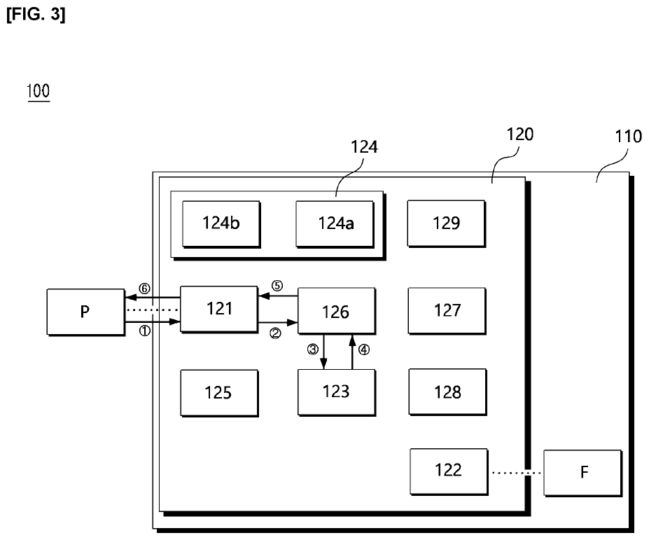

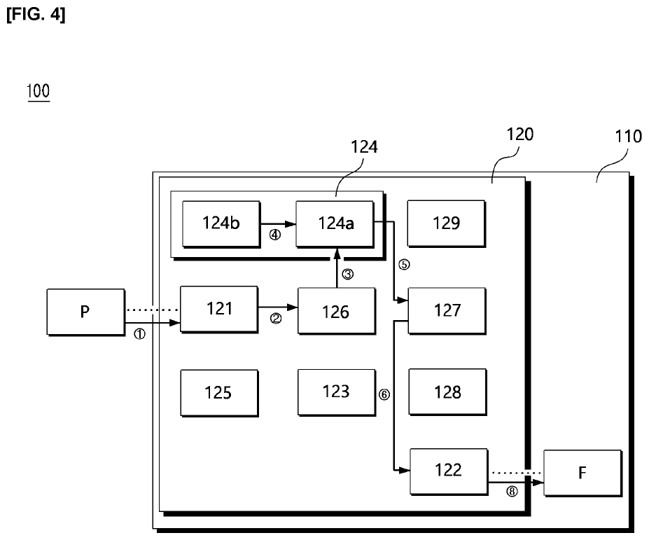

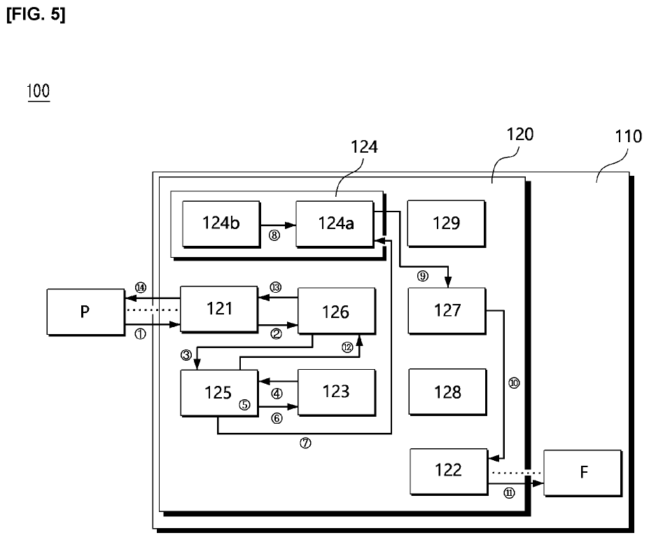

FIG. 2 illustrates the flow of operations where the information is being stored in the mirror memory when power is applied to the memory module for authentication to be installed on a recycle cartridge capable of initializing according to an embodiment of the present disclosure, FIG. 3 illustrates the flow of operations of reading the information from the mirror memory of the memory module for authentication to be installed on a recycle cartridge capable of initializing according to an embodiment of the present disclosure, FIG. 4 illustrates the flow of operations where the information of the FRAM is being written in the mirror memory of the memory module for authentication to be installed on a recycle cartridge capable of initializing according to an embodiment of the present disclosure, and FIG. 5 illustrates the flow of authentication operations of the memory module for authentication to be installed on a recycle cartridge capable of initializing according to an embodiment of the present disclosure.

First of all, operations for storing information in the mirror memory 123 when power is applied to the memory module for authentication to be installed on a recycle cartridge capable of initializing 100 according to an embodiment of the present disclosure, will be described.

As illustrated in FIG. 2, when power is applied, the resetter 129 operates to generate a reset section signal and transmits the generated reset section signal to the main controller 126. Thereafter, when the main controller 126 transmits a reading command signal to the second communicator 122, the second communicator 122 reads information stored in the FRAM, and the read information is transmitted to the decoder 128 and then decoded. Thereafter, the decoded information is stored in the mirror memory 123.

Next, operations of reading the information from the mirror memory 123 of the memory module for authentication to be installed on a recycle cartridge capable of initializing 100 according to an embodiment of the present disclosure, will be described.

As illustrated in FIG. 3, when a reading command is transmitted from the imaging device P to the first communicator 121, the main controller 126 operates to transmit an address and control signal to the mirror memory 123 and reads the information in the mirror memory 123. The read information is transmitted to the first communicator 121, and then to the imaging device P.

Next, operations for writing the information of the FRAM F in the mirror memory 123 of the memory module for authentication to be installed on a recycle cartridge capable of initializing 100 according to an embodiment of the present disclosure, will be described.

As illustrated in FIG. 4, when a writing command and information are transmitted from the imaging device P to the main controller 126, the main controller 126 transmits the data to a corresponding address of the mirror memory 123 and stores the data in the mirror memory 123, and at the same time, the main controller 126 stores the same information in the writing buffer 124a. Thereafter, the main controller 126 sequentially records the information of the corresponding address of the mirror memory 123 and the data being stored in the mirror memory 123 in the writing address pointer, wherein the writing address pointer becomes larger than the reading address pointer. Here, the writing buffer controller 124b monitors the state of the writing address pointer and the reading address pointer, and compares the size of the writing address pointer and the reading address pointer, and if the writing address pointer is larger than the reading address pointer, the writing buffer controller 124b reads the information stored in the writing buffer 124a, that is, the address and data, and transmits the address and data to the encoder 127. The writing buffer controller 124b repeats the above process while increasing the reading address pointer by the size read until the size of the writing address pointer and the size of the reading address pointer become identical to each other. The data transmitted to the encoder 127 is encoded, and then transmitted to the FRAM F through the second communicator 122, and then stored in the FRAM F.

Next, authentication operations of the memory module for authentication to be installed on a recycle cartridge capable of initializing 100 according to an embodiment of the present disclosure, will be described.

As illustrated in FIG. 5, the authentication command and the first authentication information generated from the imaging device P are transmitted to the authenticator 125 via the first communicator 121 and the main controller 126. Thereafter, the authenticator 125 reads the second authentication information from the mirror memory 123, and performs the authentication algorithm based on the read second authentication information, and then generates the authentication result signal as a result. Here, the authentication result signal consists of the first authentication result information for authentication between the imaging device P and the recycle cartridge, and the second authentication result information, that is information that may be substituted for the second authentication information, when authentication is repeated.

Thereafter, the authenticator 125 records the second authentication result information in the mirror memory 123, and thereafter, the authenticator 125 transmits the second authentication result information to the buffer 124. The second authentication result information is transmitted from the buffer 124 to the encoder 127, and then encoded, and thereafter, the encoded second authentication result information is stored in the FRAM F through the second communicator 122.

Meanwhile, the first authentication result information is transmitted from the authenticator 125 to the imaging device P through the first communicator 121, and thereafter, the imaging device P conducts authentication, which means allowing the use of the recycle cartridge using the first authentication result information.

Hereinafter, initialization operations of the memory module for authentication to be installed on a recycle cartridge capable of initializing according to an embodiment of the present disclosure will be described with reference to the drawings attached.

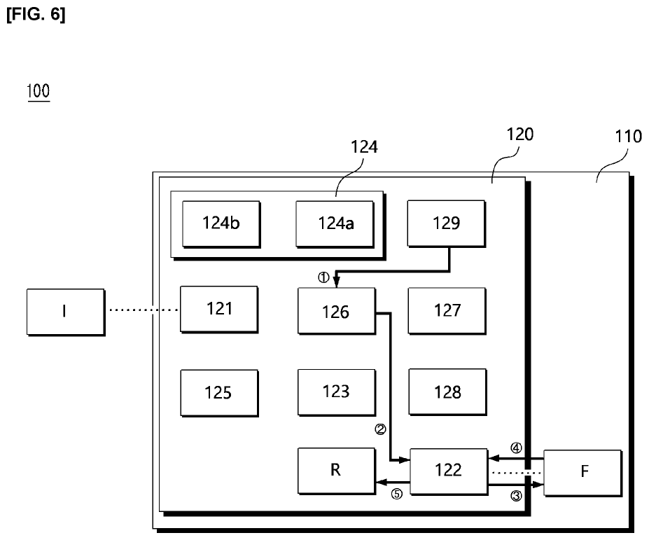

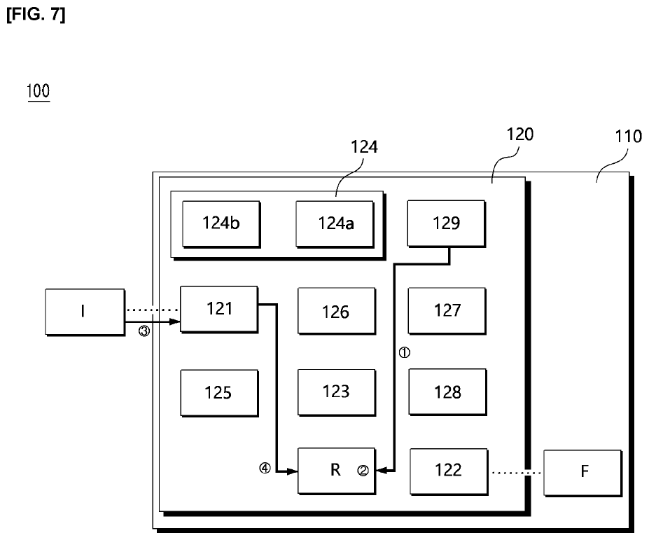

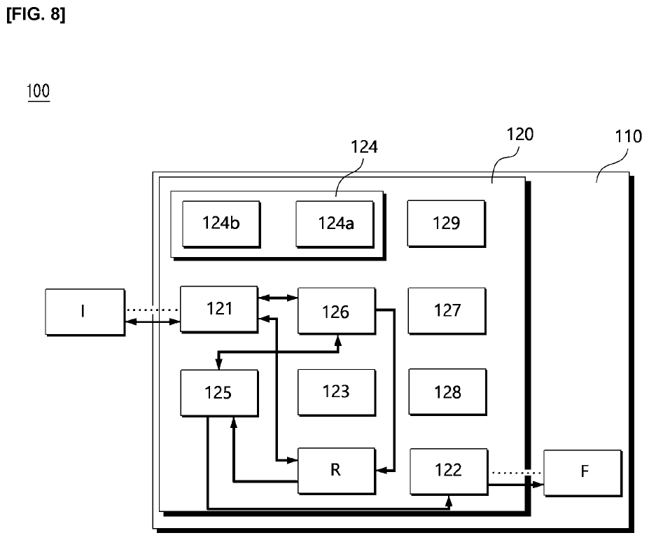

FIG. 6 illustrates a first flow of the initialization operations of the memory module for authentication to be installed on a recycle cartridge capable of initializing according to an embodiment of the present disclosure, FIG. 7 illustrates a second flow of the initialization operations of the memory module for authentication to be installed on a recycle cartridge capable of initializing according to an embodiment of the present disclosure, and FIG. 8 illustrates a third flow of the initialization operations of the memory module for authentication to be installed on a recycle cartridge capable of initializing according to an embodiment of the present disclosure.

As illustrated in FIG. 6, the resetter 129 first and foremost operates to generate the reset section signal, and then transmits the generated reset section signal to the main controller 126. Thereafter, the main controller 126 transmits the initialization data reading command to the second communicator 122. Thereafter, when initialization data of the FRAM F is transmitted to the second communicator 122, the pseudo random unit R starts to prepare to sequentially generate the pseudo random information based on the transmitted initialization data.

As illustrated in FIG. 7, when the reset section signal generated in the resetter 129 is terminated, the pseudo random unit R operates, to sequentially generate the pseudo random information. Thereafter, when the initialization authentication command is transmitted from the initialization module I to the first communicator 121, the pseudo random unit R stops operations and fixes the pseudo random information.

As illustrated in FIG. 8, when the pseudo random information that used to be sequentially generated by the pseudo random unit R is fixed by the initialization authentication command received from the initialization module I, the fixed pseudo random information is transmitted to the initialization module I and the authenticator 125, respectively, and the initialization module I and the authenticator 125 respectively perform the initialization authentication algorithm based on the transmitted pseudo random information. When the initialization authentication algorithm is normally conducted in the initialization module I, the first initialization authentication result information is generated, and when the initialization authentication algorithm is normally conducted in the authenticator 125, the second initialization authentication result information is generated.

Thereafter, the initialization module I transmits the first initialization authentication result information to the first communicator 121 so that the first initialization authentication result information is transmitted to the authenticator 125, and receives the second initialization authentication result information generated from the authenticator 125, and conducts the initialization authentication based on the first initialization authentication result information that the initialization module I generated. That is, when the first initialization authentication result information and the second initialization authentication result information are identical to each other, the authentication is completed.

Meanwhile, at the same time, the authenticator 125 conducts the initialization authentication based on the first initialization authentication result information transmitted after the initialization authentication algorithm is performed in the initialization module I and the second initialization authentication result information generated by the authenticator 125. That is, when the first initialization authentication result information and the second initialization result information are identical to each other, the authentication is completed.

When the authentication is completed in the initialization module I and the authenticator 125, respectively, the initialization module I transmits the initialization command to the main controller 126 so that the main controller 126 initializes the FRAM F.

In the above description, it is described that all the components constituting the embodiments of the present invention are combined or operated as one, but the present invention is not necessarily limited to these embodiments. In other words, within the scope of the present invention, all of the components may be selectively operated in combination with one or more.

In addition, the terms such as “comprise”, “composed of” or “have” described above, unless otherwise stated, mean that the corresponding component may be inherent, and thus it should be interpreted that the present invention may further include other components rather than excluding them. All terms, including technical and scientific terms, have the same meaning as commonly understood by one of ordinary skill in the art unless otherwise defined. Terms commonly used, such as terms defined in a dictionary, should be interpreted to coincide with the contextual meaning of the related art, and shall not be interpreted in an ideal or excessively formal sense unless explicitly defined in the present invention.

Further, the above description is merely illustrative of the technical idea of the present invention, and thus various modifications and variations will be possible by one of ordinary skill in the art within the scope without departing from the essential characteristics of the present invention.

Therefore, the embodiments disclosed in the present invention are not intended to limit the technical spirit of the present invention but to explain, and the scope of the technical idea of the present invention is not limited by these embodiments. The scope of protection of the present invention should be interpreted by the following claims, and all technical ideas within the scope equivalent thereto should be construed as being included in the scope of the present invention.

What is claimed is:

1. A memory module for authentication to be installed on a recycle cartridge capable of initializing, the memory module comprising:
a Ferroelectrics Random Access Memory (FRAM); and
a controller electrically connected to the FRAM and configured to communicate with an initialization module to perform an initialization authentication algorithm together with the initialization module, thereby initializing the FRAM when the initialization authentication is completed.

2. The memory module for authentication to be installed on a recycle cartridge capable of initializing according to claim 1,
wherein the controller comprises:
a first communicator configured to exchange information with the initialization module;
a second communicator configured to exchange information with the FRAM;
a pseudo random unit configured to generate pseudo random information based on information transmitted from the FRAM;
an authenticator configured to perform an initialization authentication algorithm based on the pseudo random information; and
a main controller configured to control the first communicator, the second communicator, the pseudo random unit and the authenticator, and when the initialization module performs the initialization authentication algorithm based on the pseudo random information and the authenticator performs the initialization authentication algorithm based on the pseudo random information, to initialize the FRAM in response to a command from the initialization module.

3. The memory module for authentication to be installed on a recycle cartridge capable of initializing according to claim 1,
wherein the FRAM stores a plurality of initial data corresponding to a plurality of types of the recycle cartridges, respectively, and
the pseudo random unit has a plurality of methods for generating a plurality of pseudo random information corresponding to the plurality of initial data based on the plurality of initial data, respectively.

4. The memory module for authentication to be installed on a recycle cartridge capable of initializing according to claim 3,
wherein the pseudo random unit is provided by a Linear Feedback Shift Register (LFSR).

5. The memory module for authentication to be installed on a recycle cartridge capable of initializing according to claim 1,
wherein the FRAM and the controller communicate in a Serial method.
